(19) United States
(12) Patent Application Publication
(10) Pub. No.: US 2009/0058061 A1
(43) Pub. Date: Mar. 5, 2009

(54) SYSTEM FOR PROVIDING AN INDICATION INDICATIVE OF WHETHER OR NOT A SEAT BELT OF A VEHICLE OCCUPANT IS FASTENED

(76) Inventors: Richard C. Fuisz, McLean, VA (US); Joseph M. Fuisz, Washington, DC (US); Justin Richard Fuisz, McLean, VA (US)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/847,599

(22) Filed: Aug. 30, 2007

(51) Int. Cl. B60R 22/48

(52) U.S. Cl. 280/801.1; 340/901

(57) ABSTRACT

A system for providing an indication indicative of whether or not a seat belt of a vehicle occupant is fastened includes a seat belt system including a seat belt and a visible marking provided on the seat belt, the marking being visible from outside the vehicle when the seat belt is fastened. Alternatively, the system includes a seat restraint system including a seat restraint system for a passenger including a seat restraint having a locked position for restraining the passenger in a seat, a sensor for sensing whether or not the seat restraint system is in the locked position, and an indicator responsive to the sensor, the indicator being accessible from outside the vehicle or at a location remote from the passenger, for displaying an indication indicative of whether or not the seat restraint system is in the locked position.

### BACKGROUND OF THE INVENTION

The present invention relates to a system for displaying an indication indicative of whether or not a seat belt of a vehicle occupant is fastened.

Currently employed seat belt systems alert the driver or driver and passenger(s) when a seat belt is not buckled. Many jurisdictions now have mandatory seat belt use requirements. However, applicants have found that a method and system are needed to enable seat belt usage to be monitored from outside the vehicle.

### BRIEF SUMMARY OF THE INVENTION

The present invention relates to a system for providing an indication external to a vehicle indicative of whether or not a seat belt of a vehicle occupant is fastened. According to one aspect of the invention, the system includes a seat belt system including a seat belt and a visible marking provided on the seat belt, the marking being visible from outside the vehicle when the seat belt is fastened.

According to another aspect of the invention, the system includes a seat restraint system including a seat restraint system for a passenger including a seat restraint having a locked position for restraining the passenger in a seat, a sensor for sensing whether or not the seat restraint system is in the locked position, and an indicator responsive to the sensor, the indicator being accessible from outside the vehicle or at a location remote from the passenger, for displaying an indication indicative of whether or not the seat restraint system is in the locked position.

### BRIEF DESCRIPTION OF THE SEVERAL VIEWS OF DRAWINGS

The present invention can be better understood with reference to the accompanying figures in which:

FIG. 1 is a schematic view of the system for providing an indication external to a vehicle indicative of whether or not a seat belt of a vehicle occupant is fastened according to a first embodiment of present invention;

FIGS. 2A and 2B are schematic views of the system for providing an indication external to a vehicle indicative of whether or not a seat belt of a vehicle occupant is fastened showing two alternatives according to a second embodiment of present invention; and

FIG. 3 is a schematic view of the system for providing an indication external to a vehicle indicative of whether or not a seat belt of a vehicle occupant is fastened according to a third embodiment of present invention.

### DETAILED DESCRIPTION OF THE INVENTION

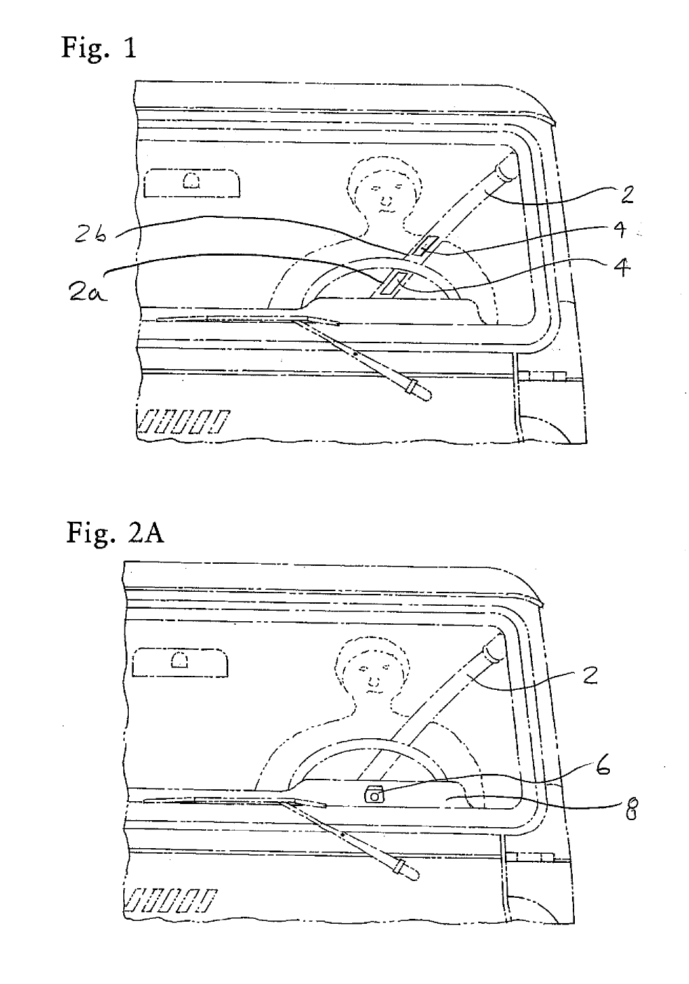

FIG. 1 is a schematic view of the system for providing an indication external to a vehicle indicative of whether or not a seat belt of a vehicle occupant is fastened according to a first embodiment of present invention. As shown in FIG. 1, a seat belt system including a seat belt 2 and a visible marking 4 provided on the seat belt 2, the marking 4 being visible from outside the vehicle when the seat belt 2 is fastened. The marking 4 can be, e.g., a light reflective material provided on a portion 2a of the seat belt worn adjacent a chest or a portion 2b of the seat belt worn adjacent shoulder area of the occupant. The marking can be made of other materials as would be understood by those skilled in the art, including phosphorescent materials. An example of a high efficiency retroreflective material that can be used to make the marking is described in U.S. Pat. No. 4,895,428, the contents of which are incorporated herein by reference. The marking can be applied to the seat belt or incorporated in the material of which the seat belt is made. Regardless of the methodology employed, e.g., dying, weaving etc., the material cannot in any way interfere with the function or strength of the seat belt. The marking is visible from outside the vehicle to enable a law enforcement official or traffic camera to determine whether the seat belt is fastened. The marking can be applied to the entire belt or to selected areas, such as the area worn adjacent the occupant's chest and/or shoulder.

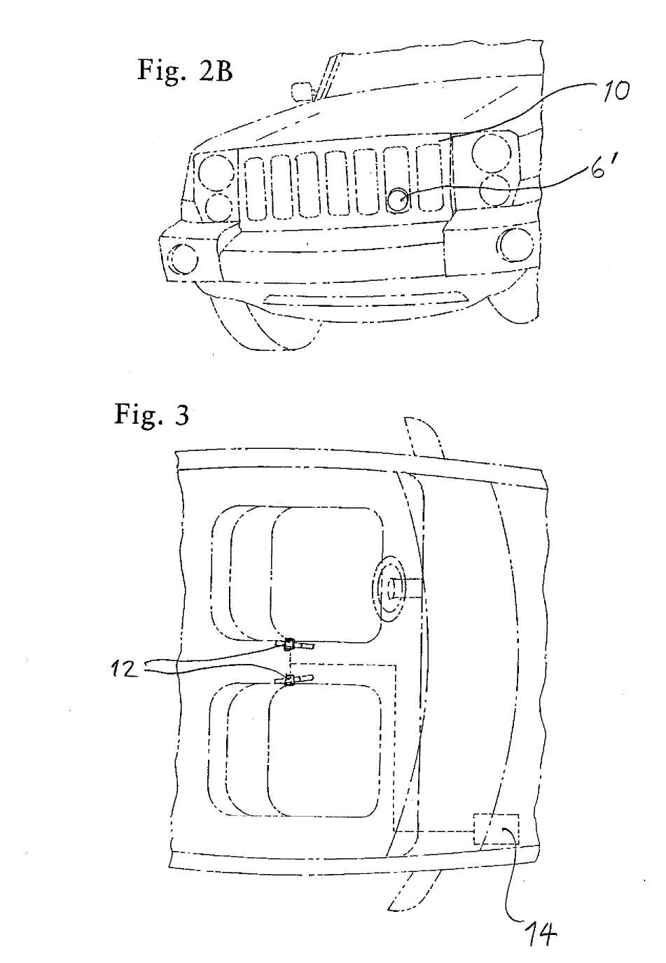

FIGS. 2A and 2B are schematic views of the system for providing an indication external to a vehicle indicative of whether or not a seat belt of a vehicle occupant is fastened showing two alternatives according to a second embodiment of present invention. According to this embodiment, the seat belt system includes a seat belt 2 having a standard tongue connector and seat belt buckle for fastening the tongue connector therein as is well known in the art. A sensor is provided for sensing whether or not the tongue connector is fastened in the seat belt buckle (see, e.g., sensors 12 in FIG. 3). Sensors for sensing whether or not the tongue connector is fastened in the seat belt buckle are also well known in the art. Examples of a seat belt buckle and sensor are described in U.S. Pat. No. 5,960,523, the contents of which are incorporated herein by reference. An indicator 6 or 6′ is provided responsive to the sensor, the indicator 6 or 6′ being accessible from outside the vehicle for displaying an indication indicative of whether or not the seat belt tongue connector is fastened in the seat belt buckle. The indicator may be an indicator light that is visible from outside the vehicle. The indicator is visible from outside the vehicle to enable a law enforcement official or traffic camera to determine whether the seat belt is fastened.

As shown in FIG. 2A, the indicator light 6 may be mounted on the dashboard 8 of the vehicle in a position in which the indicator light is visible from outside the vehicle. As shown in FIG. 2B, the indicator light 6′ is mounted in a front grill 10 of the vehicle in a position in which the indicator light is visible from outside the vehicle. Other mounting positions are of course possible.

FIG. 3 is a schematic view of the system for providing an indication external to a vehicle indicative of whether or not a seat belt of a vehicle occupant is fastened according to a third embodiment of present invention According to this embodiment, the seat belt system includes a seat belt 2 having a standard tongue connector and seat belt buckle for fastening the tongue connector therein as is well known in the art. A sensor 12 is provided for sensing whether or not the tongue connector is fastened in the seat belt buckle. Sensors for sensing whether or not the tongue connector is fastened in the seat belt buckle are also well known in the art. An indicator 14 is provided responsive to the sensor 12. The indicator 14 is accessible from outside the vehicle for displaying an indication indicative of whether or not the seat belt tongue connector is fastened in the seat belt buckle. According to this embodiment, the indicator 14 is a radio frequency transponder or passive RFID tag that can be interrogated by an interrogation device. Radio frequency transponders and passive RFID tags that can be interrogated by an interrogation device are well known and are frequently used for, e.g., toll collecting and clothing tags in retail stores. An example of such a radio frequency identification system is described in U.S. Pat. No. 6,100,804, the contents of which are incorporated herein by reference. The radio frequency transponder can be interrogated by an interrogation device operated by a law enforcement official or can be automatically interrogated by an interrogation device in an automated traffic monitoring system. That is, a law enforcement official or traffic camera system can interrogate the transponder/tag (much like a toll pass or a clothing tag in a retail store) and this indicates to enforcement if the seat belt fastened.

While the seat restraint system has been described in connection with a seat “belt,” any seat restraint system, whether or not using a belt, can be used in connection with the present invention. For example, the restraining object need not be a flexible belt but may a solid (e.g., metal or hard plastic) restraining device as on some amusement rides now. For example, a seat restraint system for a passenger or amusement park rider can include a hard, solid seat restraint having a locked position (with or without a buckle) for restraining the passenger in a seat.

The system of the present invention can be applied to all conveyances in which restraint is important, e.g., cars, trucks, buses, school buses, airplanes, amusement park rides, trains, ships, space vehicles, cyclic devices etc. The advantage of the system of the present invention is that it is easier to spot non-compliance, be that from personal observation, or from active/passive monitoring/software systems. The indicator being readable, e.g., by an operator of the truck, bus, school bus, airplane, amusement park ride, train, ship, space vehicle, or cyclic device, from a location remote from the passenger for displaying an indication indicative of whether or not the seat restraint system is in the locked position

While the accompanying figure shows and this description describe some embodiments of the invention, the invention is not limited thereto. One skilled in the art will understand that numerous variations and modifications are possible without departing from the spirit and scope of the invention defined by the following claim(s).

We claim:

1. A system for displaying an indication indicative of whether or not a seat belt of a vehicle occupant is fastened, comprising:
a seat restraint system including a seat restraint that can be fastened in a seat restraint buckle;
a visible marking provided on the seat restraint, the marking being clearly visible when the seat restraint is fastened in the seat restraint buckle.

2. The system according to claim 1, wherein the seat restraint is made of a hard solid material.

3. The system according to claim 2, wherein the marking is a light reflective material.

4. The system according to claim 1, wherein the seat restraint is a flexible seat belt provided in a vehicle and the marking is clearly visible from outside the vehicle when the seat belt is fastened in the seat restraint buckle.

5. The system according to claim 4, wherein the marking is a light reflective material provided on a portion of the seat belt worn adjacent a chest or shoulder area of the occupant.

6. The system according to claim 4, wherein a portion of the seat belt worn adjacent a chest or shoulder area of the occupant is made of a light reflective material.

7. A system for providing an indication external to a vehicle indicative of whether or not a seat belt of a vehicle occupant is fastened, comprising:
a seat restraint system including a seat restraint having a tongue connector and a seat restraint buckle for fastening the tongue connector therein;
a sensor for sensing whether or not the tongue connector is fastened in the seat restraint buckle; and
an indicator responsive to the sensor, the indicator being readable from outside the vehicle for displaying an indication indicative of whether or not the seat restraint tongue connector is fastened in the seat restraint buckle.

8. The system according to claim 7, wherein the indicator is a radio frequency transponder that can be interrogated by an interrogation device.

9. The system according to claim 8, wherein the radio frequency transponder can be interrogated by an interrogation device operated by a law enforcement official.

10. The system according to claim 8, wherein the radio frequency transponder can be automatically interrogated by an interrogation device in an automated traffic monitoring system.

11. The system according to claim 7, wherein the indicator is an indicator light that is visible from outside the vehicle.

12. The system according to claim 11, wherein the indicator light that is mounted on the dashboard of the vehicle in a position in which the indicator light is visible from outside the vehicle.

13. The system according to claim 11, wherein the indicator light that is mounted in a front grill of the vehicle in a position in which the indicator light is visible from outside the vehicle.

14. A system for providing an indication to an operator, at a location remote from the passenger, indicative of whether or not a seat restraint system of a passenger is in a locked position, comprising:
a seat restraint system for a passenger including a seat restraint having a locked position for restraining the passenger in a seat;
a sensor for sensing whether or not the seat restraint system is in the locked position; and
an indicator responsive to the sensor, the indicator being readable from a location remote from the passenger for displaying an indication indicative of whether or not the seat restraint system is in the locked position.

15. The system according to claim 14, wherein the indicator is a radio frequency transponder that can be interrogated by an interrogation device.

16. The system according to claim 15, wherein the radio frequency transponder can be automatically interrogated by an interrogation device in an automated monitoring system.

17. The system according to claim 14, wherein the indicator is an indicator light.

18. The system according to claim 14, wherein the system is provided in a bus, airplane, amusement park ride, train, ship, space vehicle and cyclic device.
